(19) United States
(12) Patent Application Publication
(10) Pub. No.: US 2016/0037043 A1
(43) Pub. Date: Feb. 4, 2016

(54) HIGH DYNAMIC RANGE (HDR) IMAGES FREE OF MOTION ARTIFACTS

(71) Applicant: OmniVision Technologies, Inc., Santa Clara, CA (US)

(72) Inventors: Xiaoyong Wang, Santa Clara, CA (US); Jizhang Shan, Cupertino, CA (US)

(21) Appl. No.: 14/449,538

(22) Filed: Aug. 1, 2014

(51) Int. Cl. H04N 5/235; G06T 5/50; G06T 5/00; G06K 9/40

(52) U.S. Cl. CPC H04N 5/2355; G06K 9/40; G06T 5/50; G06T 5/007; G06T 2207/20212; G06T 2207/10144; G06T 2207/20208

(57) ABSTRACT

Embodiments are disclosed of a process for high dynamic range (HDR) images using an image sensor with pixel array comprising a plurality of pixels to capture a first image having a first exposure time, a second image having a second exposure time, and a third image having a third exposure time, wherein of the first, second, and third exposure times the second exposure time is the shortest. The first, second, and third images are combined into a high-dynamic-range (HDR) image. Other embodiments are disclosed and claimed.

### TECHNICAL FIELD

The disclosed embodiments relate generally to image sensors and in particular, but not exclusively, to image sensors to produce high dynamic range images that are free of motion artifacts.

### BACKGROUND

In photography, contrast can be thought of as the difference between bright and dim areas of a scene; scenes with both bright and dim areas are said to have high contrast. These high-contrast scenes are difficult to capture with a camera, because contrast in real world scenes is often beyond what consumer cameras can capture.

A real-world example is taking a photograph of a person on the beach on a bright day. If the person is standing in the bright sunshine, both the person and the surrounding scene will be bright because both are illuminated by the sunlight. It is easy to capture a good picture because there is little contrast between the person and the surrounding scenery. But taking a photograph of a person under a beach umbrella is more difficult. If the person is in the shade of a beach umbrella, there is high contrast between the shady region under the umbrella and the bright sand, sea, and sky behind it. A single image of these high-contrast scenes can usually capture the image under the umbrella or the image of the background, but not both simultaneously because the two different areas require different exposure time. The short exposure time needed for the bright background will capture the background properly but will make the area under the umbrella dark and difficult to see. And the longer exposure time needed for the area under the umbrella will capture the area under the umbrella properly but leave the background overexposed and washed out.

For these situations, high dynamic range (HDR) images can be generated by capturing multiple images of the scene with different exposure times and then combining them into one image that has the proper exposure everywhere. But because the technique involves capturing multiple images, the changes in the scene—caused, for instance, by moving objects in the scene—can generate artifacts in the final image that are not actually part of the scene.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic drawing of an embodiment of an image sensor including a color filter array.

FIGS. 2A-2B are cross-sections of an embodiment of a pair of frontside illuminated pixels and an embodiment of a pair of backside-illuminated pixels, respectively.

FIG. 3 is a schematic drawing illustrating the concept of a high dynamic range (HDR) image.

FIG. 4 is a schematic drawing of an embodiment of a simplified scene with a moving element.

FIGS. 5A-5C are a drawing of an embodiment of an image capture sequence for capturing images of the scene of FIG. 4 with different exposure times (FIG. 5A), a graph the intensity characteristics of the resulting images (FIG. 5B), and a graph of the intensity characteristics of a high dynamic range (HDR) image obtained by combining the captured images (FIG. 5C).

FIGS. 6A-6C are a diagram of an embodiment of an image capture sequence for capturing images of the scene of FIG. 4 with different exposure times (FIG. 6A), a graph of the intensity characteristics of the resulting images (FIG. 6B), and a graph of the intensity characteristics of an HDR image obtained by combining the captured images (FIG. 6C).

FIGS. 7A-7C are a diagram of an embodiment of an image capture sequence for capturing images of the scene of FIG. 4 with different exposure times (FIG. 7A), a graph of the intensity characteristics of the resulting images (FIG. 7B), and a graph of the intensity characteristics of the HDR image obtained by combining the captured images (FIG. 7C).

FIGS. 8A-8C are diagrams of an embodiment of an image capture sequence for capturing images of the scene of FIG. 4 with different exposure times (FIG. 8A), a graph of the intensity characteristics of the resulting images (FIG. 8B), and a graph of the intensity characteristics of the HDR image obtained by combining the captured images (FIG. 8C).

FIGS. 8D-8E are diagrams of other embodiments of image capture sequences.

FIG. 9 is a flowchart of an embodiment of a process for assembling a high dynamic range (HDR) image from two or more images.

### DETAILED DESCRIPTION OF ILLUSTRATED EMBODIMENTS

Embodiments are described of an apparatus, system and method for image sensors to create high dynamic range images that are free of motion artifacts. Specific details are described to provide a thorough understanding of the embodiments, but one skilled in the relevant art will recognize that the invention can be practiced without one or more of the described details, or with other methods, components, materials, etc. In some instances, well-known structures, materials, or operations are not shown or described in detail but are nonetheless encompassed within the scope of the invention.

Reference throughout the description to “one embodiment” or “an embodiment” means that a described feature, structure, or characteristic can be included in at least one described embodiment. Hence appearances of “in one embodiment” or “in an embodiment” do not necessarily all refer to the same embodiment. Furthermore, the described features, structures, or characteristics can be combined in any suitable manner in one or more embodiments.

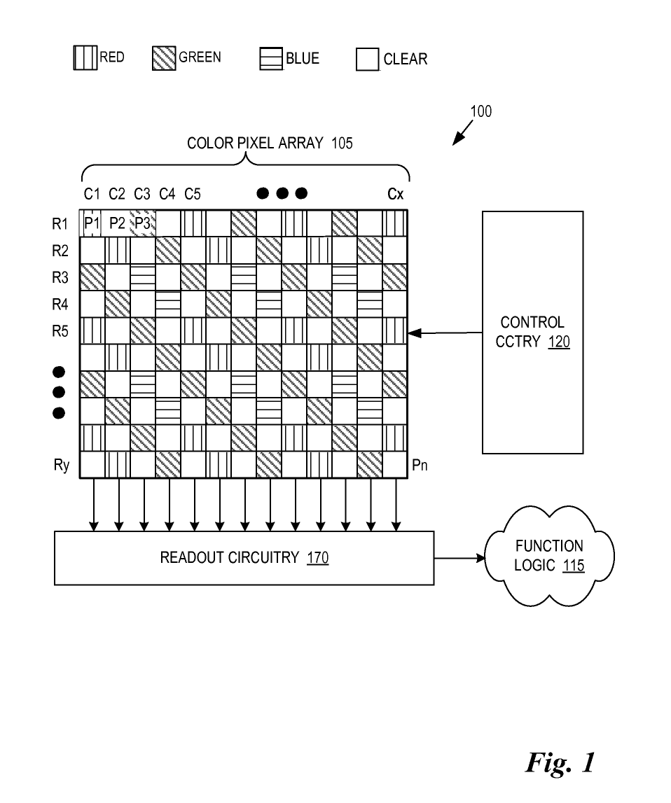

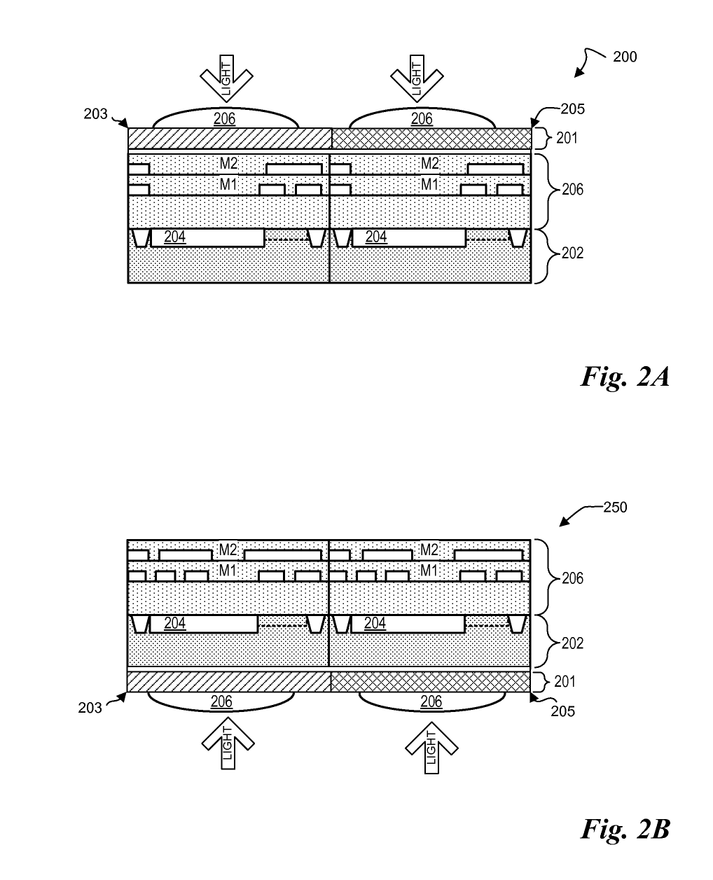

FIG. 1 illustrates an embodiment of a complementary metal oxide semiconductor (CMOS) image sensor 100 including a color pixel array 105, readout circuitry 170 coupled to the pixel array, function logic 115 coupled to the readout circuitry, and control circuitry 120 coupled to the pixel array. Color pixel array 105 can be implemented in a frontside-illuminated image sensor, as shown in FIG. 2A, or as a backside-illuminated image sensor, as shown in FIG. 2B. Color pixel array 105 is a two-dimensional (2D) array of individual imaging sensors or pixels (e.g., pixels P1, P2 . . . , Pn) arranged into X pixel columns and Y pixel rows. As illustrated, each individual pixel in the array is arranged into a row (e.g., rows R1 to Ry) and a column (e.g., column C1 to Cx) to acquire image data of a person, place, or object. The image data or pixel data can then be used to render a 2D image of the person, place, or object. Color pixel array 105, if present, assigns color to each pixel using a color filter array (“CFA”) coupled to the pixel array.

After each pixel in pixel array 105 has acquired its image data or image charge, the image data is read out from the individual pixels by readout circuitry 170 and transferred to function logic 115 for storage, additional processing, etc. Readout circuitry 170 can include amplification circuitry, analog-to-digital (“ADC”) conversion circuitry, or other circuits. Function logic 115 can store the image data and/or manipulate the image data by applying post-image effects (e.g., crop, rotate, remove red eye, adjust brightness, adjust contrast, high dynamic range (HDR) image combination, or otherwise). Function logic 115 can also be used in one embodiment to process the image data to correct (i.e., reduce or remove) fixed pattern noise. Control circuitry 120 is coupled to pixel array 105 to control operational characteristic of the pixel array 105. For example, control circuitry 120 can generate a shutter signal for controlling image acquisition.

FIG. 2A illustrates a cross-section of an embodiment of a pair of frontside-illuminated (FSI) pixels 200 in a CMOS image sensor. The front side of FSI pixels 200 is the side of substrate 202 upon which the photosensitive area 204 and associated pixel circuitry are disposed, and over which metal stack 206 for redistributing signals is formed. Metal stack 206 includes metal layers M1 and M2, which are patterned to create an optical passage through which light incident on FSI pixels 200 can reach photosensitive or photodiode (“PD”) regions 204. To implement a color image sensor, the front side can include color filter arrangement 201, with each of its individual color filters (individual filters 203 and 205 are illustrated in this particular cross section) disposed under a microlens 206 that aids in focusing incident light onto PD region 204.

FIG. 2B illustrates a cross-section of an embodiment of a pair of backside-illuminated (BSI) pixels 250 in a CMOS image sensor. As in FSI pixels 200, the front side of pixels 250 is the side of substrate 202 upon which the photosensitive regions 204 and associated pixel circuitry are disposed, and over which metal stack 206 is formed for redistributing signals. The backside is the side of substrate 202 opposite the front side. To implement a color image sensor, the backside can include color filter array 201, with each of its individual color filters (individual filters 203 and 205 are illustrated in this particular cross section) disposed under a microlens 206. Microlenses 206 aid in focusing incident light onto photosensitive regions 204. Backside illumination of pixels 250 means that the metal interconnect lines in metal stack 206 do not obscure the path between the object being imaged and the photosensitive regions 204, resulting in greater signal generation by photosensitive regions 204.

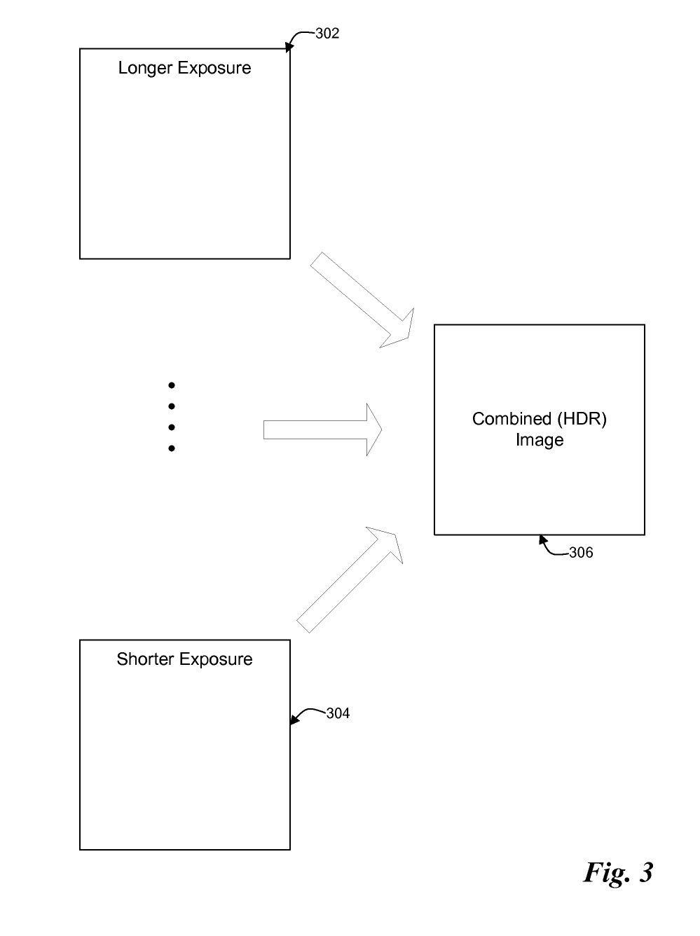

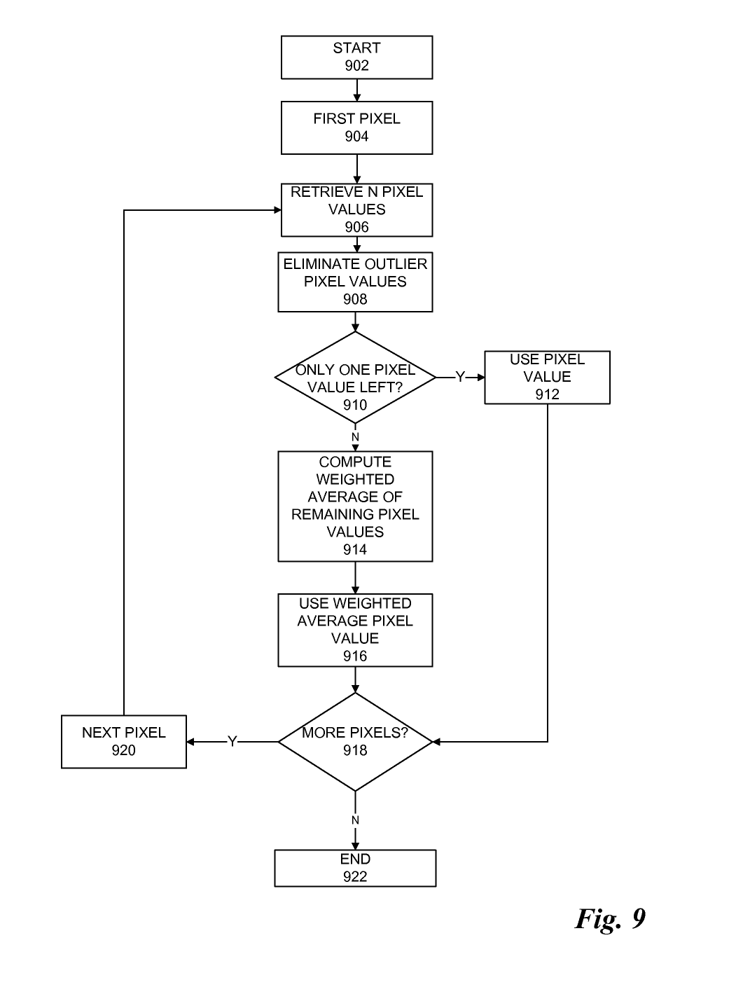

FIG. 3 is a schematic illustration of an embodiment of assembling a high dynamic range (HDR) image. To form an HDR image, two or more images of a scene are captured and then assembled into an HDR image, for example with the process shown in FIG. 9 in one embodiment. In the illustrated example, a first image 302 having a long exposure time is captured, along with one or more subsequent images including a second image 304 with a short exposure time. The terms “long” and “short,” as used describe exposure times, are relative; the actual durations of the two are immaterial, so long as one is longer than the other. First image 302, second image 306, and any other captured images can then be combined into a single HDR image 306.

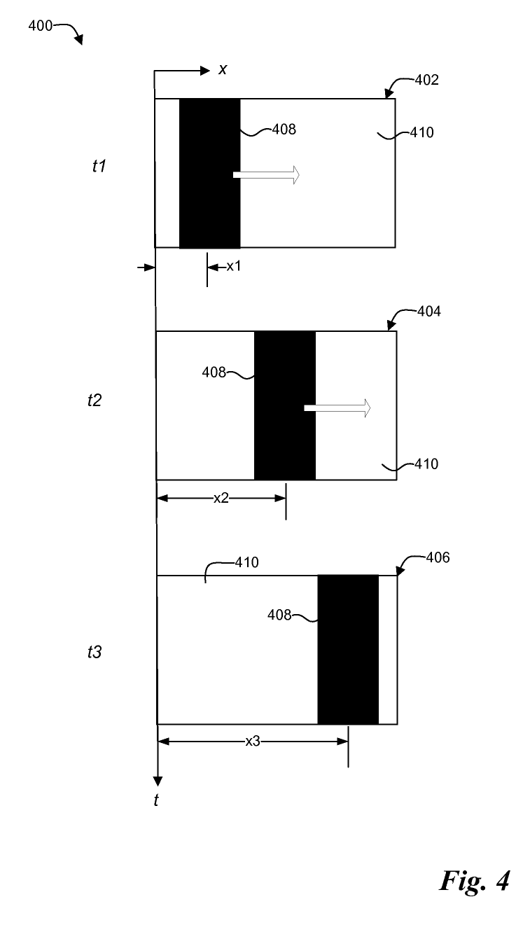

FIG. 4 illustrates an embodiment of a simplified scene 400 that includes motion in the scene and that will be used in the description that follows. Of course, scene 400 is only an illustrative example; real-world scenes can have many more objects with different intensities, colors, positions, and movements than shown. In the figure the vertical axis represents time, increasing in the downward direction, and the horizontal axis represents the x position of black bar 408 in the scene, measured from the left border of the scene. In scene 400 a black bar 408 moves from left to right across a white background 410, so that scene 400 changes over time.

In the initial scene state 402 at time t1, black bar 408 is at position x1, x1≧0. In a second state 404, at a time t2 later than t1 (i.e., t2>t1), black bar 408 is at position x2>x1, meaning that in time t2−t1 black bar 408 moved to the right across white background 410 by a distance x2−x1. In the third scene 406, at time t3>t2, black bar 408 has moved further to the right, to position x3>x2. The challenge in imaging a scene with moving objects such as scene 400 is to capture multiple images of the scene and combine them into a high dynamic range (HDR) image that captures black bar 408 and white background 410 but is free of motion artifacts—things that appear in the image due to the motion, but are not actually part of the scene—caused by the motion of black bar 408 across white background 410.

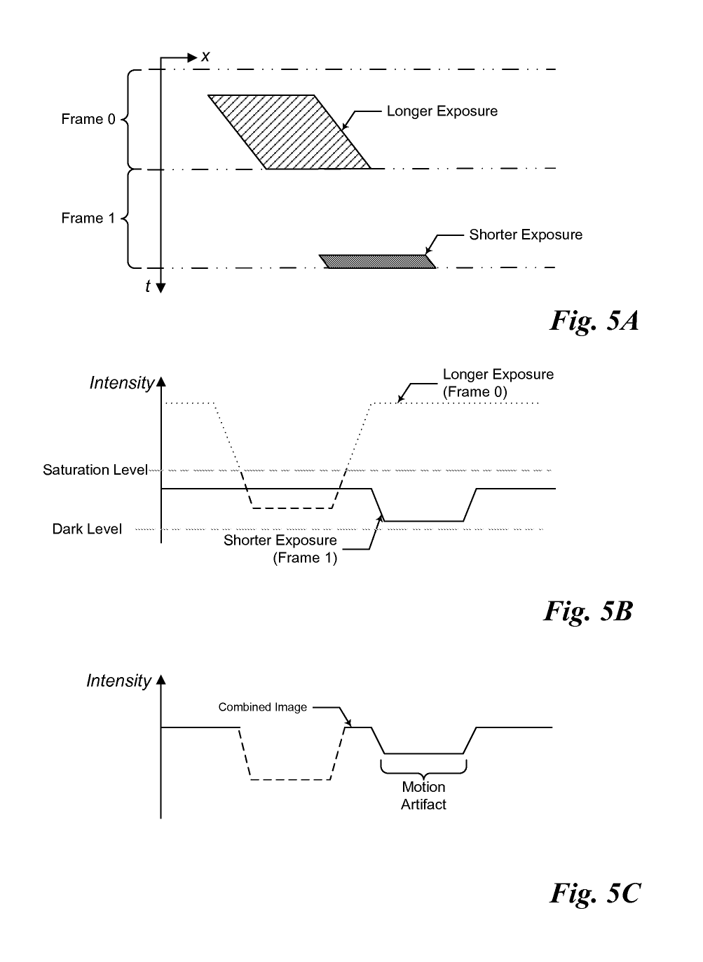

FIGS. 5A-5C together illustrate an embodiment of a process for capturing multiple individual images and using them to form an HDR image. The illustrated embodiment uses the scenes shown in FIG. 4 as an example, but of course the process is not limited to such scenes and can be used for any kind of scene in which there is motion. FIG. 5A illustrates an embodiment of an image capture sequence; similarly to FIG. 4, the horizontal axis represents movement through space, while the vertical axis represents time. The parallelogram shape of the exposure periods in FIG. 5A is caused by movement of black bar 408 across the scene during the exposure periods and between exposure periods; if the black bar were stationary the shape of the exposure periods in FIG. 5A would be a rectangle instead of a parallelogram.

In the illustrated sequence, two images are captured in two different image sensor frames. An image sensor frame is a period of time during which the image sensor captures and reads out an image before starting a new frame to capture another image; the number of frames an image sensor captures each second is referred to as its frame rate. In the illustrated image capture sequence a long exposure image is captured first in frame 0, followed, after a delay, by the capture of a short exposure image in frame 1. The terms “long” and “short,” as used describe exposure times, are relative; the actual durations of the two are immaterial, so long as one is longer than the other.

FIG. 5B is a graph illustrating representative image intensities for the long- and short-exposure images captured as shown in FIG. 5A. In the long-exposure image the intensity exceeds the sensor saturation level in areas of the image that correspond to white portion 410 of the scene, but drops below saturation level in the area of the image corresponding to black bar 408. In the short-exposure image the intensity is below the saturation level over the entire image and, as in the long-exposure image, drops to a lower level in the area of the image corresponding to black bar 408. The black bar shows up in different positions in the two exposures because black bar 408 is moving and because of the time difference between the end of the long-exposure image capture and the beginning of the short-exposure image capture.

FIG. 5C is a graph showing a representative image intensity for an embodiment of an HDR image combines the long- and short-exposure images of FIG. 5B using an embodiment of an HDR combination process such as the one shown in FIG. 9. As can be seen, the combined (HDR) image includes a motion artifact—that is, something that appears in the image because of motion in the scene but is not actually part of the scene—caused by the movement of the black bar between and during exposures.

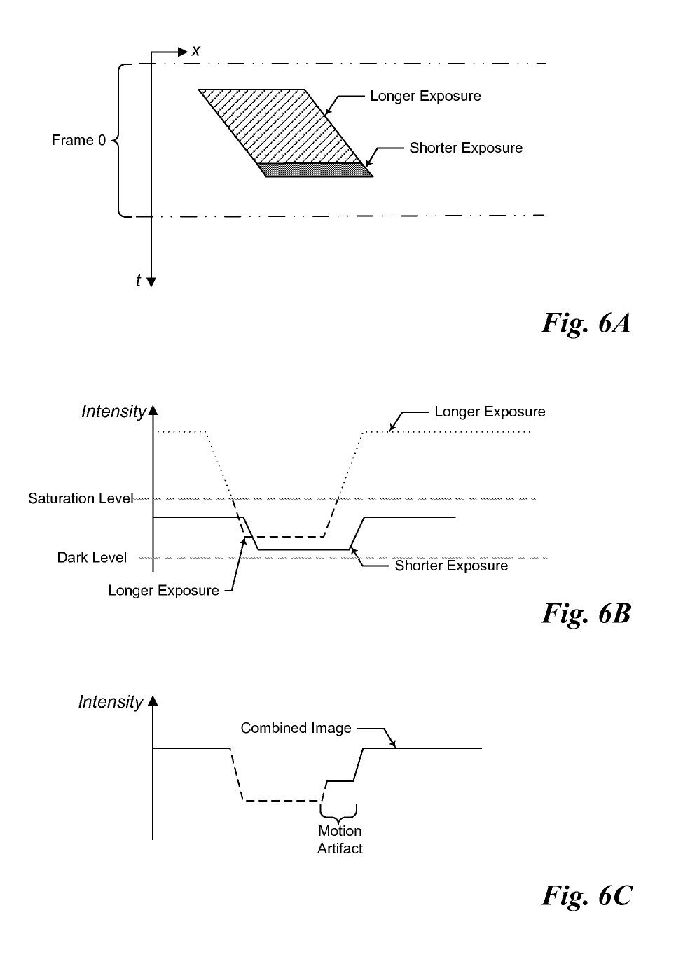

FIGS. 6A-6C together illustrate another embodiment of a process for capturing multiple individual images and using them to form an HDR image. The illustrated embodiment uses scene 400 as an example, but of course the process is not limited to such scenes and can be used for any kind of scene in which there is motion. FIG. 6A illustrates an embodiment of an image capture sequence. As in FIG. 5A, two separate images are captured of a moving black bar 408 on white background 410. But in FIG. 6A both images are captured within the same image sensor frame by increasing the frame rate of the image sensor—this is known as “staggering” the images. The first image captured is a long-exposure image is, followed with little or no delay by capture of a second short-exposure image. The terms “long” and “short,” as used to describe exposure times, are relative; the actual durations of the two are immaterial as long as they are of different durations.

FIG. 6B is a graph of representative image intensities for the long- and short-exposure images of FIG. 6A. In the longer exposure image the intensity exceeds the sensor saturation level in areas of the image that correspond to white portion 410 of the scene, but drops below saturation level in the area of the image corresponding to black bar 408. In the short exposure the intensity is below the saturation level over the entire image and, as in the longer exposure, drops to a lower level in the part of the image corresponding to black bar 408. Because black bar 408 is moving it shows up in a different position in the two exposures, but because of the reduced or eliminated time difference between capture of the long and short exposure images in FIG. 6A, the image of the black bar is less shifted between the long- and short-exposure images than in FIGS. 5A-5C.

FIG. 6C is a graph of representative intensity from an HDR image assembled using the long- and short-exposure images of FIG. 6A and a process such as the one shown in FIG. 9. As before, the HDR image includes a motion artifact caused by capturing separate images of the moving black bar at two different times and with non-zero exposure times. In FIG. 6C the motion artifact is smaller in comparison with FIG. 5C because of the reduced or eliminated time between capture of the long- and short-exposure images. Nonetheless, the motion artifact is not completely eliminated from the resulting HDR image.

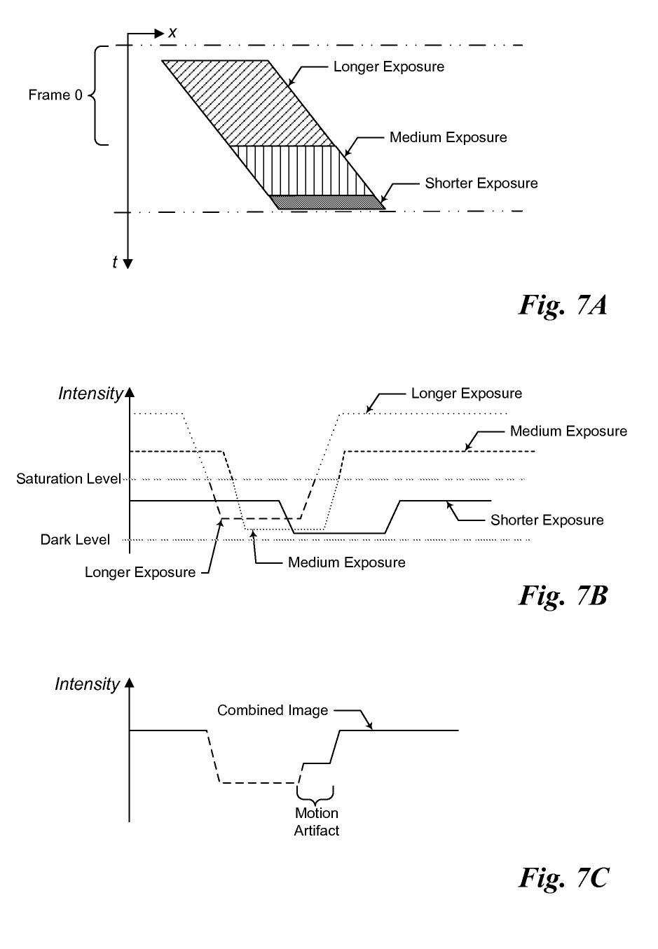

FIG. 7A-7C together illustrate another embodiment of a process for capturing multiple individual images and using them to form an HDR image. The illustrated process uses the scene 400 as an example, but of course is not limited to such a scene. FIG. 7A illustrates an embodiment of an image capture sequence. In the illustrated sequence, three images are captured of black bar 408 moving across white background 410. All three images are “staggered,” meaning they are captured within the same frame by accelerating the image sensor's frame rate. The long-exposure image is captured first, followed with little or no delay by capture of a medium-exposure image, and then followed with little or no delay by the capture of a short-exposure image. The terms “long,” “medium,” and “short,” as used to describe exposure times, are relative; the actual durations of the three are immaterial so long as they are of three different durations.

FIG. 7B is a graph of representative image intensities for the long, medium, and short exposure images of FIG. 7A. In the long-exposure image the intensity exceeds the sensor saturation level in areas of the image corresponding to white portion 410, but drops below saturation level in the part of the image corresponding to black bar 408. The medium-exposure image has an intensity level between the long- and short-exposure images, and the intensity exceeds saturation in parts of the image but falls below saturation in the parts of the image that correspond to black bar 408. In the short exposure the intensity is below saturation level over the entire image and, as in the longer exposure, drops to a lower level in the part of the image corresponding to black bar 408. The non-zero exposure times and the time difference between image captures, together with the motion of black bar 408, causes the black bar to show up in a different position in the three exposures.

But because of the reduced or eliminated time difference between image captures in FIG. 7A, the image of the black bar is less shifted between exposures that it is in FIGS. 5A-5C.

FIG. 7C is a graph of the representative intensity from an HDR image assembled using the images of FIG. 7B and a process such as the one shown in FIG. 9. As before, the HDR image includes a motion artifact caused by capturing separate images of the moving black bar at three different times and with non-zero exposure times. In FIG. 7C the motion artifact is lessened in comparison to FIG. 5C by the reduced or eliminated time between exposures, as well as by the sequence of exposure times, but the motion artifact is not completely eliminated from the resulting HDR image.

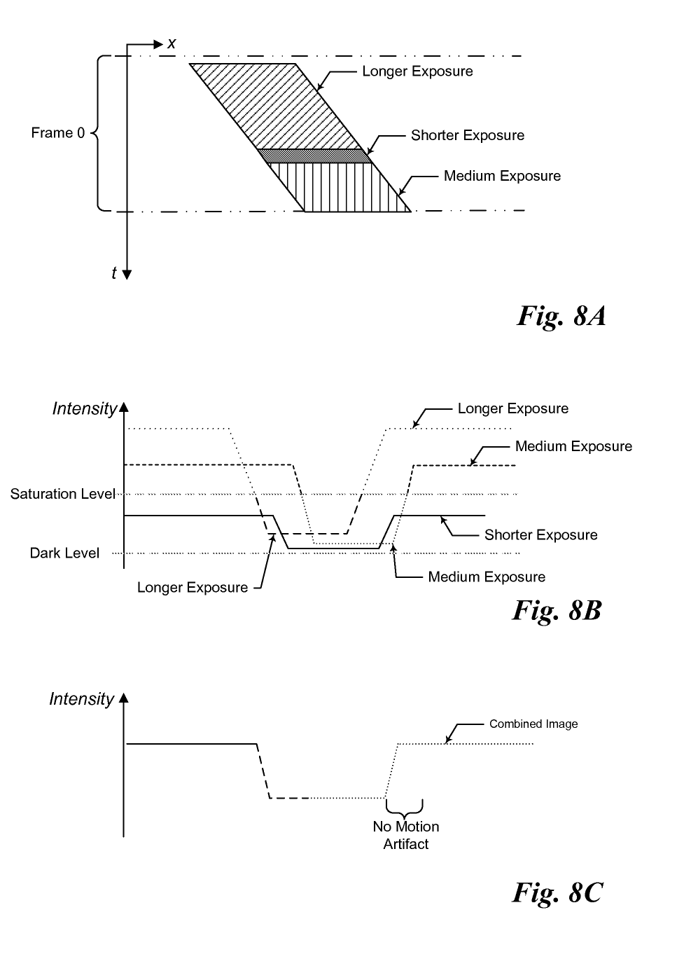

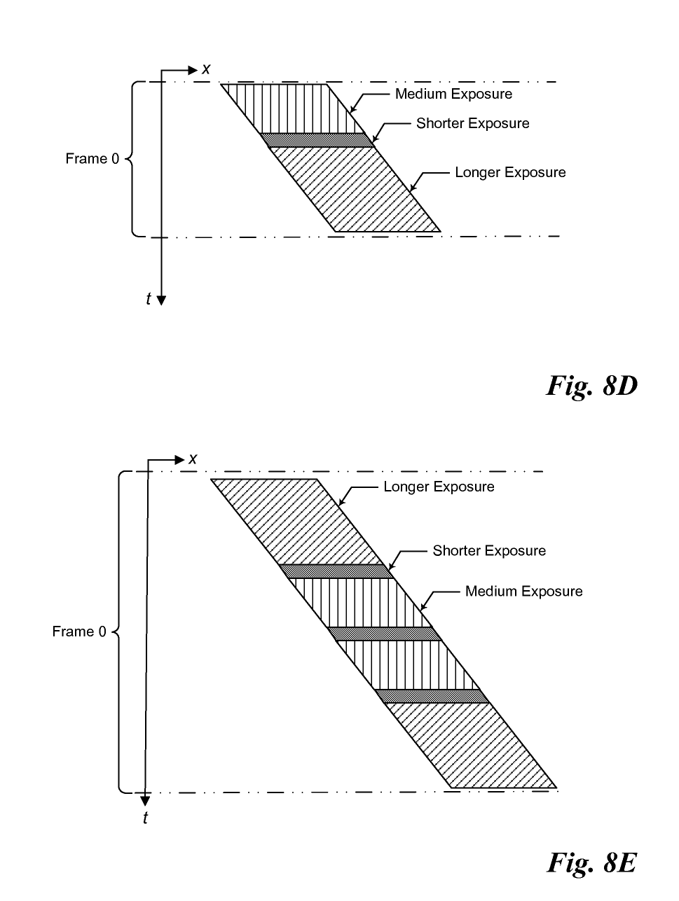

FIG. 8A-8C together illustrate another embodiment of a process for capturing multiple individual images and using them to form an HDR image. The illustrated process uses scene 400, but of course is not limited to such a scene. FIG. 8A illustrates an embodiment of an image capture sequence. The illustrated sequence captures three images. The three images are “staggered,” meaning they are captured within the same frame by accelerating the frame rate of the image sensor. The long-exposure image is captures first, followed with little or no delay by capture of a short exposure image, and then followed with little or no delay by capture of a medium exposure image. The terms “long,” “medium,” and “short,” as used to describe exposure times, are relative; the actual durations of the three are immaterial so long as they are of three different durations.

FIG. 8B is a graph of representative image intensities for the long-, short-, and medium-exposure images of FIG. 8A. In the long-exposure image the intensity exceeds the sensor saturation level in areas of the image corresponding to white portion 410, but drops below saturation level in the part of the image corresponding to black bar 408. In the short exposure the intensity is below saturation level over the entire image and, as in the longer exposure, drops to a lower level in the part of the image corresponding to black bar 408. The medium-exposure image has an intensity level between the long- and short-exposure images, and the intensity exceeds saturation in parts of the image but falls below saturation in the parts of the image that correspond to black bar 408. The non-zero exposure times and the time difference between image captures, together with the motion of black bar 408, causes the black bar to show up in a different position in the three exposures. But because of the reduced or eliminated time difference between image captures in FIG. 8A, the image of the black bar is less shifted between exposures that it is in FIGS. 5A-5C.

FIG. 8C is a graph of representative intensity from an HDR image assembled using the images of FIG. 8A and a process such as the one shown in FIG. 9. In FIG. 8C there is no motion artifact due to the motion of black bar 408; the motion artifact is eliminated by one or both of the reduced or eliminated time between exposures and the long-short-medium sequence of exposure times.

FIG. 8D illustrates another embodiment of an image capture sequence. The image capture sequence shown in FIG. 8A captures three images, with capture of a long-exposure image first, followed with little or no delay by capture of a short-exposure image, followed with little or no delay by the capture of a medium-exposure image. But the image capture sequence is not listed not limited to this long-short-medium sequence. In the embodiment of FIG. 8D, for instance, the image capture sequence is medium-short-long: capture of a medium-exposure image comes first, followed with little or no delay by capture of a short-exposure image, followed with little or no delay by the capture of a long-exposure image. The three images are “staggered,” meaning they are captured within the same frame by accelerating the frame rate of the image sensor. The two sequences shown in FIGS. 8A and 8D are symmetrical, so they are equivalent and both can be used to produce a final HDR image that is free of motion artifacts as shown in FIGS. 8B-8C.

FIG. 8E illustrates another embodiment of an image capture sequence. The image capture sequence shown in FIG. 8A captures three images, but the image capture sequence is not limited to this number of images; FIG. 8E illustrates an embodiment of an image capture sequence that captures more than three images. In the illustrated sequence, multiple images are captured of the scene shown in FIG. 4. The three images are “staggered,” meaning they are captured within the same frame by accelerating the frame rate of the image sensor. Capture of a long-exposure image comes first, followed with little or no delay by capture of a short-exposure image, followed with little or no delay by the capture of a medium-exposure image. One or more additional images are captured following capture of the medium-exposure image. The illustrated embodiment shows four additional image captures, but the additional image captures can be any number and need not be in a particular sequence of exposure times, as long as the first three images follow the long-short-medium exposure time sequence.

FIG. 9 illustrates an embodiment of a process for combining images into a high dynamic range (HDR) image. The process starts at block 902, by which time N images will have already been captured with the pixel array of an image sensor, where N is an integer; for the embodiment illustrated in FIGS. 8A-8C, for instance, N is equal to 3 because 3 images are captured. More generally, in an embodiment in which N images have been captured, they will be N pixel values for each pixel in the pixel array.

Block 904 starts with the first pixel in the array. At block 906, the process retrieves the N pixel values available for the pixel being processed and then continues to block 908, where it eliminates outlier values from among the N pixel values. Outlier pixel values are pixel values that fall outside a specified range—either above or below—or values that are at or near certain limits. Outlier pixel values can be defined differently in different embodiments, but in one embodiment outliers can include values exceeding the saturation value of the image sensor and values that are at or close to the dark value.

Block 910 checks to see whether there is only one pixel value left after eliminating outliers. If at block 910 only one pixel value remains after eliminating outliers, at block 912 that remaining pixel value is assigned to be the pixel value for that pixel in the HDR image. But if at block 910 more than one pixel value is left after eliminating outliers, the process continues to block 914, which computes a weighted average of the remaining pixel values. In one embodiment, the weighted average pixel value can be computed according to the formula:

$$\overline{P} = \frac{{\sum }_{1}^{N} {w}_{i} {P}_{i}}{{\sum }_{1}^{N} {w}_{i}}$$

in which P̅ is the weighted average pixel value for the particular pixel, Pᵢ are the remaining pixel values (after eliminating outliers) for that particular pixel, and wᵢ are weights assigned to the pixel values. In one embodiment, the weights wᵢ assigned to each pixel value can be assigned according to the signal quality, so that a pixel value based on a better-quality signal has more influence in the weighted average. Signal quality can be defined differently in different embodiments, but in one embodiment it can be defined as the signal-to-noise ratio of the signal. Other embodiments can, of course, apply different weighting schemes to the pixel values. Having computed the weighted average pixel value at block 914, the process moves to block 916, which assigns the computed weighted average pixel value as the value of that particular pixel in the final HDR image.

At block 918 the process checks to see whether more pixels remain to be processed. If at block 918 more pixels remain to be processed, the process moves to block 920, where it selects the next pixel, and then returns to block 906 and repeats the process for the new pixel. But if at block 918 there are no more pixels, meaning that the entire image has been processed, then the process ends at block 922.

The above description and what is described in the abstract are not intended to present every possible option or to limit the invention to the precise embodiments disclosed. Specific embodiments are described for illustrative purposes, but various equivalent modifications are possible in light of the above detailed description within the scope of the invention, as those skilled in the relevant art will recognize.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A process for high dynamic range (HDR) images, the process comprising:
using an image sensor with pixel array comprising a plurality of pixels to capture a first image having a first exposure time, a second image having a second exposure time, and a third image having a third exposure time, wherein:
of the first, second, and third exposure times the second exposure time is the shortest,
the first, second, and third images are separate images captured within a single image sensor frame, and
the time between capturing the first image and capturing the second image and the time between capturing the second image and capturing the third image are substantially zero; and
combining the first, second, and third images into a high-dynamic-range (HDR) image.

2. The process of claim 1 wherein among the first, second, and third exposure times the first is the longest and the second is the shortest.

3-4. (canceled)

5. The process of claim 1 wherein among the first, second, and third exposure times the third is the longest and the second is the shortest.

6. The process of claim 1, further comprising:
capturing one or more additional images after capturing the third image; and
combining the first, second, third, and the one or more additional images into an HDR image.

7. The process of claim 1 wherein each image comprises a plurality of pixel values and combining the first, second, and third images to form an HDR image comprises, for every pixel in the pixel array:
eliminating any outlier pixel values;
if only one pixel value remains after eliminating outlier pixel values, assigning the remaining pixel value as value of the pixel in the HDR image; and
if multiple pixel values remain after eliminating outlier pixel values, computing a weighted average pixel value as a weighted average of the non-outlier pixel values and assigning the weighted average pixel value as value of the pixel in the HDR image.

8. The process of claim 7 wherein the pixel value having the best signal quality is weighted most heavily in the weighted average computation.

9. The process of claim 7 wherein an outlier pixel value is a pixel value that exceeds the saturation threshold of the image sensor or a pixel value that is at, near, or below the dark value of the image sensor.

10. An apparatus comprising:
a pixel array including a plurality of pixels;
readout circuitry coupled to the pixel array to capture a first image having a first exposure time, a second image having a second exposure time, and a third image having a third exposure time, wherein:
of the first, second, and third exposure times the second exposure time is the shortest,
the first, second, and third images are separate images captured within a single image sensor frame, and
the time between capturing the first image and capturing the second image and the time between capturing the second image and capturing the third image are substantially zero; and
processing circuitry and function logic coupled to the readout circuitry to combine the first, second, and third images into a high-dynamic-range (HDR) image.

11. The apparatus of claim 10 wherein among the first, second, and third exposure times the first is the longest and the second is the shortest.

12-13. (canceled)

14. The apparatus of claim 10 wherein among the first, second, and third exposure times the third is the longest and the second is the shortest.

15. The apparatus of claim 10, further comprising:
capturing one or more additional images after capturing the third image; and
combining the first, second, third, and the one or more additional images into an HDR image.

16. The apparatus of claim 10 wherein each image comprises a plurality of pixel values and combining the first, second, and third images to form an HDR image comprises, for every pixel in the pixel array:
eliminating any outlier pixel values;
if only one pixel value remains after eliminating outlier pixel values, assigning the remaining pixel value as value of the pixel in the HDR image; and
if multiple pixel values remain after eliminating outlier pixel values, computing a weighted average pixel value as a weighted average of the non-outlier pixel values and assigning the weighted average pixel value as value of the pixel in the HDR image.

17. The apparatus of claim 16 wherein the pixel value having the best signal quality is weighted most heavily in the weighted average computation.

18. The apparatus of claim 16 wherein an outlier pixel value is a pixel value that exceeds the saturation threshold of the image sensor or a pixel value that is at, near, or below the dark value of the image sensor.
